(19) United States
(12) Patent Application Publication
(10) Pub. No.: US 2002/0050756 A1
(43) Pub. Date: May 2, 2002

(54) Absolute position detecting device for a linear actuator

(76) Inventor: Yoshinori Ito, Nagano-ken (JP)

Correspondence Address: ROSENTHAL & OSHA L.L.P., 1221 MCKINNEY AVENUE, SUITE 2800, HOUSTON, TX, 77010, US

(21) Appl. No.: 09/912,938

(22) Filed: Jul. 25, 2001

(30) Foreign Application Priority Data
Jan. 25, 2000 (JP) P-2000-15440

(51) Int. Cl. H02K 13/04; H02K 23/50; H02K 27/16; H02K 27/24

(52) U.S. Cl. 310/135

(57) ABSTRACT

A rotary absolute signal A is obtained that shows the absolute rotary position at each revolution of the motor based on the output obtained from a rotary encoder 5 affixed to the motor output shaft 2a, and a linear absolute signal B is obtained that shows the absolute linear position per linear stroke pitch along an axial direction 3a of the output shaft 3 based on an output obtained from a linear absolute sensor 6 which is a magnetic induction type sensor and is mounted on the actuator output shaft 3. The distance Lp by which the output shaft 3 is moved per motor revolution and the detection pitch Sp of the linear absolute sensor are set at different values, so in the period until the values become equal, at no point of the output shaft movement is the same absolute signal combination produced. Therefore, the combination of the signals can be used to enable absolute linear position detection over a long stroke.

### BACKGROUND OF THE INVENTION

1. Field of the Invention

The present invention relates to an absolute position detecting device for detecting an absolute position along the axial direction of a linear actuator. More particularly, the invention relates to an absolute position detecting device that has a simple structure and can detect an absolute position over the range of a long stroke.

2. Description of the Prior Art

Methods for detecting an absolute position on the axis of a linear actuator include a method in which a linear absolute sensor is attached to the actuator shaft, and a method in which a multi-turn type rotary absolute sensor is attached to the actuator shaft on which is formed a ball-screw. A linear actuator generally has a motor, an output shaft, and a converting mechanism for converting the rotary output of the motor to linear motion. The converting mechanism comprises a ball-screw coupled to the motor output shaft, a ball-nut through which the center of the output shaft passes, and a spline that supports the output shaft so that the output shaft can only move axially.

With the former method in which a linear absolute sensor is used to detect the absolute position of the output shaft of a linear actuator thus configured, a linear encoder is attached to the actuator output shaft. In this case, a magnetic induction type sensor can be used as the linear absolute sensor. A magnetic induction sensor is capable of absolute position detection within a one-pitch range, and can be applied to both rotary and linear types.

FIG. 2 shows an example of an arrangement where a magnetic induction sensor is built in to the output shaft of a linear actuator. As shown, the magnetic induction sensor 6 includes a magnetic pattern 61 formed at a fixed pitch along the axial direction 3a of the output shaft 3, and a detection coil 62 around the magnetic pattern 61. In this case, one detection pitch corresponds to one pitch of the magnetic pattern 61, and in the axial direction it is possible to detect an absolute position within the space of that one pitch. Generally the resolution is 15 to 16 bits, so if one pitch is 16 mm, for example, it is possible to achieve a resolution of approximately 0.25 to 0.5 micron.

With the latter method in which a rotary absolute sensor is used to detect an absolute linear position on the linear actuator output shaft 3, a multi-turn type absolute sensor is attached to the motor encoder attached to the output shaft of the motor.

However, with the method that uses a linear absolute sensor, when the resolution is increased, there is a proportional decrease in the measurement distance. Moreover, a long-stroke linear absolute sensor capable of a long measurement distance at high resolution is very costly.

When it is desired to detect an absolute position over a long distance when a magnetic induction type sensor is used as a linear absolute sensor, it can be done by detecting what the number of the detection pitch is. Normally, the output of the detection coil is used as a basis for counting the pitch number, and the count value is maintained in memory that has a battery backup. However, this is not a desirable arrangement since the reliability of the measurement depends on the reliability of the battery, and it requires the provision of a battery and a counter, thereby increasing the cost.

On the other hand, the rotary absolute sensor used in the latter method is larger than a linear type sensor, and backlash in the ball-screw thread gives rise to measurement error that cannot be avoided.

### SUMMARY OF THE INVENTION

In consideration of the defects of the conventional absolute position detecting device of a linear actuator capable of detecting an absolute position over the range of a long stroke, a main object of the present invention is to provide an absolute position detecting device that can detect an absolute position of a linear actuator over the range of a long stroke that has a simple structure and is inexpensive.

Focusing on the encoder attached to the output shaft of the motor used to drive the linear actuator, in accordance with the absolute position detecting device for a linear actuator according to the present invention, by using the output of the encoder and the output of a linear absolute sensor attached to the actuator output shaft, it becomes possible to detect an absolute position over the range of a long stroke, or more preferably, over the range of the entire stroke. It is of course also possible to achieve this object by utilizing the output of a rotary absolute sensor attached to the motor output shaft that can detect the absolute rotary position at each rotation.

Namely, the present invention provides an absolute position detecting device for a linear actuator having a motor, an output shaft, and a conversion means for converting output rotation of the motor to linear motion of the output shaft, comprising: a rotary absolute sensor that detects an absolute rotary position per rotation of the motor; a linear absolute sensor that detects an absolute linear position within a set range of movement of the output shaft; calculation means for calculating an absolute linear position of the output shaft based on a combination of an output of the rotary absolute sensor and an output of the linear absolute sensor; the range of movement of the output shaft over which the absolute linear position can be detected by the linear absolute sensor being different from a distance by which the output shaft is moved per rotation of the motor as converted by the conversion means.

### BRIEF DESCRIPTION OF THE DRAWINGS

FIG. 1 shows the general configuration of an absolute position detecting device for a linear actuator according to the present invention.

FIG. 2 is an explanatory drawing of a magnetic induction type sensor incorporated into the output shaft of a linear actuator.

FIG. 3 is a signal waveform diagram for explaining the principle of absolute position detection according to the invention.

### SYMBOLS

1 linear actuator

2 motor

2a motor output shaft

3 actuator output shaft

4 conversion means

41 ball-screw

5 rotary encoder

6 magnetic induction type sensor (linear absolute sensor)

7 drive control circuit

10 absolute position detecting device

### DESCRIPTION OF THE PREFERRED EMBODIMENT

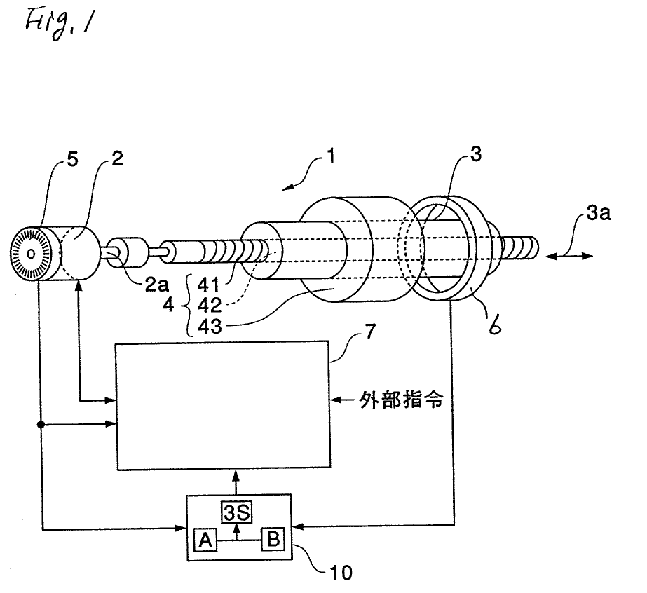

The absolute position detecting device for a linear actuator of this invention is described below, with reference to FIGS. 1 to 3.

FIG. 1 shows the general configuration of an absolute position detecting device for a linear actuator of the present invention. Linear actuator 1 includes a motor 2, an output shaft 3 and a conversion means 4 for converting the output rotation of the motor 2 into linear motion of the output shaft 3. In this example the conversion means 4 comprises a ball-screw 41 coupled with the motor output shaft 2a, a ball-nut 42 formed along the output shaft 3, and a spline 43 that supports the output shaft 3 so that the output shaft 3 can only move in the axial direction 3a.

There is also a microcomputer-based drive control circuit 7 that is used to control the motor 2, in accordance with external commands, to move the output shaft 3 to a target position. The control of the movement of the output shaft 3 is effected by feedback control based on absolute linear position information 3S on the output shaft 3 obtained from an absolute position detection device 10.

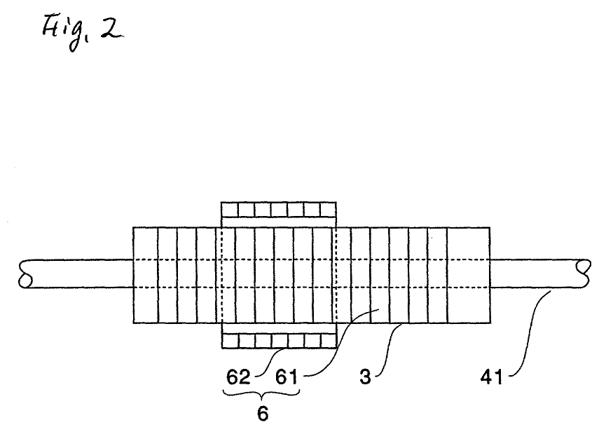

Based on a signal output by a rotary encoder 5 affixed to the motor 2 and a signal output by a magnetic induction type linear absolute sensor 6 (FIG. 2) affixed to the output shaft 3, the absolute position detection device 10 calculates the absolute linear position of the output shaft 3 in the axial direction 3a, and supplies the thus-calculated absolute linear position information 3S to the drive control circuit 7.

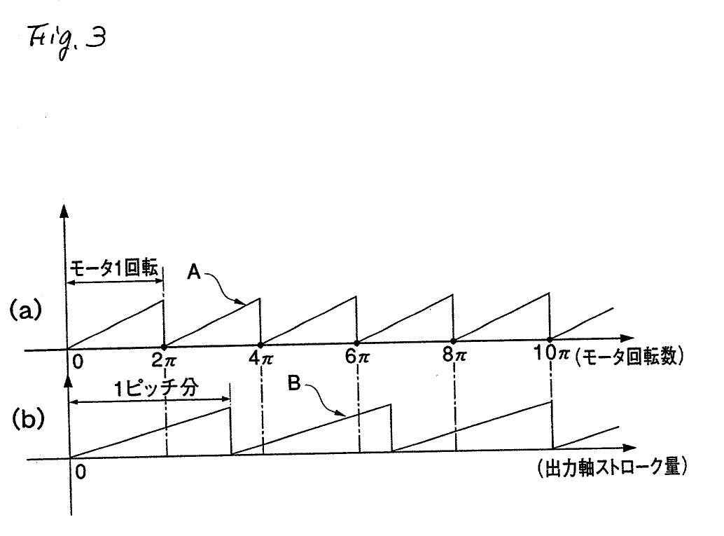

The method used to calculate the absolute linear position in the absolute position detection device 10 will now be explained with reference to FIG. 3. FIG. 3(a) is a rotary absolute signal A that shows the absolute rotary position at each rotation of the motor based on the output obtained from the rotary encoder 5 affixed to the motor output shaft 2a. FIG. 3(b) is a linear absolute signal B that shows the absolute linear position per linear stroke pitch based on the output obtained from the linear absolute sensor 6 affixed to the actuator output shaft 3. Based on the signals output by the sensors 5 and 6, the signals A and B are generated by a signal processing circuit (not shown) in the absolute position detection device 10.

With each rotation of the motor 2, the actuator output shaft 3 is moved linearly in the axial direction by an amount that is in accordance with the lead pitch of the ball-screw 41. Here, the combination of signal A and signal B will be examined. If Lp is the amount by which the output shaft 3 is moved per rotation of the motor and Sp is the detection pitch (one linear-stroke pitch) as detected by the linear absolute sensor, and Lp Sp, then, if signals A and B are combined, even if the output shaft 3 moves within the space of the movement interval until aLp=bSp (where a and b are arbitrary coefficients), at no point of the movement is the combination of the signals A and B the same. Therefore, provided that the values of coefficients a and b are sufficiently large, it is possible to realize a linear absolute sensor that, based on the combination of the two signals, can detect the absolute position of the output shaft in the axial direction over a long stroke.

In particular, since in this embodiment the absolute rotational position per motor revolution is acquired using the rotary encoder 5 that is usually affixed to the motor, there is no need to attach a separate sensor to detect the absolute rotational position. This is advantageous in that it prevents the linear actuator becoming overly large and expensive.

In the above embodiment the conversion means is configured with a ball-screw. However, it is to be understood that the present invention can also be applied to a linear actuator that uses a different conversion means. Also, the sensor used to detect the absolute rotational position per motor revolution is not limited to the above-described rotary encoder, it being possible to use a different type of rotary position detection sensor. Similarly, the linear absolute sensor is not limited to a magnetic induction type sensor, it being possible to use another type of detection sensor.

As described in the foregoing, the absolute position detecting device for a linear actuator according to the present invention detects the absolute linear position of the output shaft of a linear actuator based on a combination of an absolute rotation signal representing the absolute rotational position per motor revolution obtained from the encoder affixed to the output shaft of the linear actuator motor, and a linear absolute signal representing the absolute position per axial detection pitch obtained from a linear absolute sensor affixed to the actuator output shaft.

Therefore, in accordance with this invention, it is possible to detect an absolute linear position over the long-stroke range of a linear actuator, using a construction that is simple and not costly. In particular, when the absolute rotational position per motor revolution is obtained by utilizing the output of the motor control encoder mounted on the motor, absolute linear position can be detected over a long stroke with an apparatus of reduced size and cost, since unlike in the case of a prior art linear absolute sensor there is no need to add another sensor for the linear actuator.

What is claimed is:

1. An absolute position detecting device for a linear actuator having a motor, an output shaft, and a conversion means for converting output rotation of the motor to linear motion of the output shaft, comprising:
a rotary absolute sensor that detects an absolute rotary position per rotation of the motor;
a linear absolute sensor that detects an absolute linear position within a set range of movement of the output shaft; and,
calculation means for calculating an absolute linear position of the output shaft based on a combination of an output of the rotary absolute sensor and an output of the linear absolute sensor; wherein
the range of movement of the output shaft over which the absolute linear position can be detected by the linear absolute sensor is different from a distance by which the output shaft is moved per rotation of the motor as converted by the conversion means.

2. The device according to claim 1, wherein the rotational absolute sensor is a motor control encoder affixed to the motor output shaft.
